(19) United States
(12) Patent Application Publication
(10) Pub. No.: US 2007/0249733 A1
(43) Pub. Date: Oct. 25, 2007

(54) High Molecular Substance Beads Having Water-Insoluble Inorganic Compounds Encapsulated Therein, Their Preparation Method and Use

(76) Inventors: Eunhee Bae, Seoul (KR); Dongsin Lee, Gyeonggi-do (KR); Jisuk Choi, Gyeonggi-do (KR); Kyung-Ho Roh, Seoul (KR)

Correspondence Address: BUCHANAN, INGERSOLL & ROONEY PC, POST OFFICE BOX 1404, ALEXANDRIA, VA, 22313-1404, US

(21) Appl. No.: 11/628,234

(22) PCT Filed: Jun. 2, 2005
(86) PCT No.: PCT/KR05/01651

§ 371 Date: Dec. 1, 2006

(30) Foreign Application Priority Data
Jun. 3, 2004 (KR) 10-2004-0040551
Jan. 7, 2005 (KR) 10-2005-0001663

(51) Int. Cl. C08J 3/215

(52) U.S. Cl. 514/769; 523/223

(57) ABSTRACT

The present invention relates to polymer beads having a water-insoluble inorganic compound encapsulated therein, and their preparation method and use. In the present invention, the water-insoluble inorganic compound which has limitations on its use because of the characteristic of precipitates in an aqueous solution is encapsulated in the polymer beads. This encapsulation provides an increase in the utility of the water-insoluble inorganic compound and at the same time, imparts the activity of the water-insoluble inorganic compound to the polymer, thus increasing the function of the polymer. Accordingly, the polymer beads having the water-insoluble inorganic compound encapsulated therein, which are prepared by the inventive method, can be advantageously used in various fields, including medical and electronic industries.

### TECHNICAL FIELD

The present invention relates to polymer beads having water-insoluble inorganic compounds encapsulated therein, and their preparation method and use.

### BACKGROUND ART

As the various functions or physiological activities of polymers, such as chitosan, alginic acid and hyaluronic acid, are found out, the polymers are used as materials in various fields. For example, chitosan acting on promoting the differentiation of bone formation cells and facilitating the bone formation is used as a bone filling material, and alginic acid is used as a support for tissue regeneration or of drug delivery systems. However, if these polymers are used with a substance having the same or a similar function, capable of increasing the function (or activity) of the polymers, or a substance capable of overcoming the disadvantages of the polymers, the utility and function of the polymers can be further increased as compared to using the polymers alone. Particularly, it is highly preferred that a polymer used in tissue regeneration, such as chitosan, be used together with various biological factors or physiologically active substances which are expressed and regulated according to the regeneration of each tissue, rather than that the polymer is used alone. Accordingly, various studies to improve the polymers with various functional substances (or physiologically active substances) have been recently attempted to increase the utility and function of the polymers. For example, method for microsphere preparation containing functional substances by the phase separation of water/oil or oil/water. Also there was a method for coating the surface of the polymers with various functional substances or linking the functional substances to the polymers by inducing chemical binding.

Meanwhile, many inorganic compounds are used in various applications, including bone filling materials, compound semiconductors, cosmetic raw materials and ink paints. Among them, calcium phosphate, calcium sulfate and the like are known to show an excellent effect on bone regeneration and bone hardening. Calcium phosphate-based inorganic compounds which are generally used as artificial bone material include hydroxyapatite (HA), calcium phosphate tribasic(Ca₃(PO₄)₂) and calcium pyrophosphate (CPP; Ca₂P₂O₇). Among them, hydroxyapatite is the main inorganic component consisting 60-70% of the bone mass and causes the osteoconduction of the surrounding bone by virtue of excellent bio-fitness and biocompatibility. Therefore, studies on artificial bone materials using hydroxyapatite and on experimental and clinical application of them are now in active progress. Also, calcium sulfate is known to induce the growth of blood vessels and osteogenic cells, to harden bones and to be biocompatible. Furthermore, it is reported by various studies that inorganic materials, such as magnesium, manganese and zinc, show an effect on the regeneration of tissue in vivo. Titanium oxide (TiO₂) or zinc oxide (ZnO) is used in the form of very small particles in either cosmetics applied to sensitive skin or baby cosmetics. However, such inorganic compounds are mostly water-insoluble precipitates in an aqueous solution. Thus, in the use of them directly in vivo, there are limitations on the in vivo ingestion, absorption and migration of such precipitates. Particularly, such precipitates have a problem in that they are not easy to induce binding to other substances due to a very low reactivity. Thus, there is an urgent need for a method of effectively binding the water-insoluble inorganic compounds to the polymers so as to increase the utility of the water-insoluble inorganic compounds or to increase the function of the polymers.

### DISCLOSURE OF THE INVENTION

During studies on a method for effectively binding the water-insoluble inorganic compounds to the polymers, the present inventors prepared polymer beads having water-insoluble inorganic compounds encapsulated therein, and complete the present invention.

Therefore, it is an object of the present invention to provide polymer beads having water-insoluble inorganic compounds encapsulated therein.

Another object of the present invention is to provide a method for preparing the polymer beads.

Still another object of the present invention is to provide a use of the polymer beads.

To achieve the above objects, in one aspect, the present invention provides polymer beads having water-insoluble inorganic compounds encapsulated therein.

In another aspect, the present invention provides a method for preparing polymer beads having water-insoluble inorganic compounds encapsulated therein, the method comprising the steps of: (a) mixing a polymer solution with a compound having a ionic group of a water-insoluble inorganic compound; (b) dropping onto a solvent the mixed solution obtained in the step (a) so as to induce the formation of beads; (c) reacting the beads formed in the step (b) with an aqueous solution of a compound having a counter-ionic group to the ionic group in the step (a); and (d) washing and drying the beads resulting from the step (c).

In another aspect, the present invention provides a bone filling composition containing said polymer beads having water-insoluble inorganic compounds encapsulated therein.

As used herein, the term “water-insoluble inorganic compound” refers to an inorganic compound existing in the form of precipitates in an aqueous solution. For example, the water-insoluble inorganic compound includes metal phosphate, metal carbonate and metal oxide. Preferably, the water-insoluble inorganic compound is selected from the group consisting of calcium sulfate (CaSO₄), lead sulfide (PbS), magnesium hydroxide (Mg(OH)₂), zinc hydroxide (Zn(OH)₂), zinc carbonate (ZnCO₃) and calcium phosphate tribasic(Ca₃(PO₄)₂).

Hereinafter, the present invention will be described in detail.

The present invention provides polymer beads and the method for preparing polymer beads in which water-insoluble inorganic compounds, which have limitations on their uses (in vivo ingestion, absorption, migration and so on) since they form precipitates in an aqueous solution, encapsulated therein by the production of inorganic salt crystals caused by the chemical binding between molecules constituting the inorganic compound in the beads.

In the present invention, before the constituting molecules of the water-insoluble inorganic compound chemically bind to each other, a compound having one ionic group of the constituting molecules of the water-insoluble inorganic compound is first mixed with a polymer solution. In this regard, the ionic group is preferably the same ionic group (cationic group or anionic group) as a reactive group of the polymer. The mixed solution becomes gelation in a solvent so as to induce the formation of beads containing the same ionic group as the reactive group of the polymer. Then, an aqueous solution of a compound having a counterionic group (cationic group or anionic group) which binds to the ionic group (cationic group or anionic group) so as to form precipitates in an aqueous solution is reacted with the polymer beads. In this process, the polymer is crosslinked by the counterionic group to make the shape of the beads stronger, and at the same time, the ionic groups in the beads chemically bind to each other so as to form a water-insoluble crystalline inorganic compounds. This results in the inventive polymer beads having the water-insoluble inorganic compounds encapsulated therein. FIG. 1 schematically shows a process for preparing the polymer beads according to the present invention. The polymer beads having the water-insoluble inorganic compounds encapsulated therein were first disclosed in the present invention.

Hereinafter, each step of a method for preparing the inventive polymer beads according to the present invention will be described in detail.

Step (a)

A polymer solution is mixed with a compound having the ionic group of the water-insoluble inorganic compound.

A polymer which can be used in the present invention is preferably a biocompatible polymer. More preferably, the polymer may be selected from the group consisting of chitosan, alginic acid and hyaluronic acid. Most preferably, chitosan may be used. The polymer may be prepared in a solution form by dissolving a suitable amount of the polymer in a suitable solvent. For example, a chitosan solution may be prepared using acetic acid as a solvent. Preferably, the chitosan solution may be prepared by dissolving 3-7% (w/v) chitosan in 0.5-2% (v/v) acetic acid. An alginic acid solution and a hyaluronic acid solution may be prepared using triple distilled water. The alginic acid solution may preferably be prepared by dissolving 0.5-5% (w/v) alginic acid in triple distilled water. Also, the hyaluronic acid solution may preferably be prepared by dissolving at most 1% (w/v) hyaluronic acid in triple distilled water.

Moreover, the ionic group is the same ionic group as the reactive group of the polymer. Namely, the ionic group will be a cationic group when the reactive group of the polymer is cationic, and the other way it will be an anionic group when the reactive group is anionic. For example, since the reactive group of chitosan is cationic, a compound having a cationic group is mixed with chitosan, and since the reactive group of alginic acid is anionic, a compound having an anionic group is mixed with alginic acid. Specifically, as the compound having the ionic group of the water-insoluble inorganic compound (hereinafter, referred to as an “ionic compound”), any compound having one ionic group of the water-insoluble inorganic compound, i.e., a cationic group (e.g., Ca²⁺, Pb²⁺, Mg²⁺, Zn²⁺, etc.) or an anionic group (e.g., SO₄²⁻, S²⁻, OH⁻, HPO₄²⁻, etc.), may be used without limitation. The compound having the cationic group of the water-insoluble inorganic compound (hereinafter, referred to as a “cationic compound”) is preferably any one selected from the group consisting of calcium chloride (CaCl₂), lead nitrate (Pb(NO₃)₂), magnesium chloride (MgCl₂) and zinc chloride (ZnCl₂). Also, the compound having the anionic group of the water-insoluble inorganic compound (hereinafter, referred to as an “anionic compound”) is preferably selected from the group consisting of sodium sulfate (Na₂SO₄), sodium sulfide (Na₂S), sodium hydroxide (NaOH), sodium phosphate dibasic (Na₂HPO₄) and sodium carbonate (Na₂CO₃).

The mixing of the polymer solution with the ionic compound is preferably conducted at 18-60° C. Particularly, if chitosan or alginic acid as the polymer is mixed with a polyvalent ionic compound (divalent or higher ionic compound), the mixing will preferably be conducted at 25-60° C. This is caused by the fact that chitosan or alginic acid shows reversible sol-gel conversion depending on temperature in the presence of ions (e.g., Ca²⁺ ions).

Step (b)

The mixed solution prepared in the step (a) is dropped onto a solvent so as to induce the formation of beads.

The mixed solution of the ionic compound and the polymer solution is added dropwise to the solvent so as to induce the formation of beads through gelation or phase separation. As the solvent, any one selected from the group consisting of oil-base solvent, ethanol, acetone, liquefied nitrogen, and methanol may be used. Also, the solvent preferably has a temperature of −270° C. to 10° C. Particularly, the oil-base solvent is preferably used at −10° C. to 4° C., and ethanol is used at −40° C. to −20° C. After the mixed solution is added dropwise to the solvent, the mixture is preferably left to stand for 15-180 minutes. By this step, the mixed solution of the ionic compound and the polymer is prepared into beads containing the ionic group of the water-insoluble compound.

Step (c)

The beads formed in the step (b) are reacted with an aqueous solution of a compound having a counter-ionic group to the ionic group used in the step (a).

As the compound having the counter-ionic group to the ionic group used in the step (a), a compound having an anionic group may be used if a cationic compound is used in the step (a), and the other way, a compound having a cationic group may be used if an anionic compound is used in the step (a). As the compound having the counter-ionic group to the ionic group of the water-insoluble inorganic compound used in the step (a), any compound may be used without limitation if it has an ionic group which not only binds to the ionic group used in the step (a) so as to form a water-insoluble inorganic compound but also binds to the reactive group of the polymer so as to crosslink the polymer. Preferably, this compound is any one selected from the group consisting of calcium chloride (CaCl₂), lead nitrate (Pb(NO₃)₂), magnesium chloride (MgCl₂), zinc chloride (ZnCl₂), sodium sulfate (Na₂SO₄), sodium sulfide (Na₂S), sodium hydroxide (NaOH), sodium phosphate dibasic (Na₂HPO₄) and sodium carbonate (Na₂CO₃). By this step, the counterionic group introduced into the beads chemically interacts with the ionic group present already in the beads formed in the step (b) so as to form water-insoluble inorganic salt crystals, and at the same time, to crosslink the polymer. The counterionic group acts as a sole ionic crosslinker in the inventive polymer beads. As a result, the polymer beads having the water-insoluble crystalline inorganic compounds encapsulated therein are prepared.

For example, if calcium chloride is used in the step (a), an aqueous sodium sulfate solution may be added and reacted with the beads formed in the step (b). The following formula 1 shows an interaction of sulfate ions (SO₄²⁻) with the amino group of chitosan. By the crosslinking of the polymer by the sulfate ions, the shape of the beads becomes stronger and at the same time, the calcium ions present already in the beads interact with the sulfate ions so as to form calcium sulfate crystals in the beads.

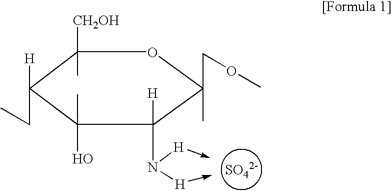

Step (d)

The beads obtained in the step (c) are washed and dried.

The washing process is preferably conducted at least five times with IPA (isopropylalcohol) and/or distilled water. By this washing process, water-insoluble inorganic salt crystals adhered to the outer surface of the beads are removed. Also, the drying process may be performed by a freeze-drying or heat-drying process. The freeze-drying process is preferably used for preparing porous beads and the heat-drying process is preferably used for preparing high-density beads.

The inventive polymer beads prepared by the above-described method preferably have any water-insoluble inorganic compounds selected from the group consisting of calcium sulfate (CaSO₄), lead sulfide (PbS), magnesium hydroxide (Mg(OH)₂), zinc hydroxide (Zn(OH)₂), calcium phosphate tribasic(Ca₃(PO₄)₂) and zinc carbonate (ZnCO₃).

In one embodiment of the present invention, chitosan beads having calcium sulfate encapsulated therein (hereinafter, referred to as calcium sulfate-containing chitisan beads) were prepared with calcium chloride (cationic compound), sodium sulfate (anionic compound) and chitosan (polymer). In this case, as a solvent for inducing the gelation of the mixed solution of the cationic compound and the polymer, an oil-base solvent was used. The prepared calcium sulfate-containing chitosan beads were analyzed, and as a result, it is determined that the sulfate ions effectively crosslinked the chitisan chains, and that the chitisan beads had calcium sulfate crystals encapsulated therein (see FIGS. 3 to 7). On the other hand, in case where the mixed solution of the cationic compound and the polymer were reacted directly with a solution of anionic compounds without gelling (or phase separation), beads were not formed (data not shown).

In another embodiment of the present invention, other various solvents than the oil-base solvent were used to prepare calcium sulfate-containing chitisan beads. As a result, it was shown that, even in case of using other solvents, beads were well prepared (see FIG. 8) and had calcium phosphate encapsulated therein (see FIG. 9).

In still another embodiment of the present invention, chitosan beads having encapsulated therein other inorganic compounds than calcium sulfate, respectively, were prepared (see FIG. 10). The analysis for each of the prepared chitosan beads showed that all beads had the water-insoluble inorganic compound encapsulated therein (see FIGS. 11 to 12).

As described above, in the present invention, we develop the polymer beads having the water-insoluble inorganic compound crystals encapsulated therein, which formed by the binding of the anionic group and cationic group of the water-insoluble inorganic compound. The polymer beads prepared according to the inventive method contain about 0.2-0.6 mg of water-insoluble inorganic compounds per mg of the polymer beads.

The polymer beads having the water-insoluble inorganic compound encapsulated therein, which is prepared according to the inventive method, may be used in various fields, including medicine and electronics, depending on the characteristics of the water-insoluble inorganic compound encapsulated therein and/or the polymer.

For example, polymer beads containing calcium sulfate or calcium phosphate may be used for the formation of hard tissue, such as bone filling or tooth regeneration. Also, since magnesium ions are not easily absorbed in the intestines, polymer beads containing magnesium sulfate may be used for improving the absorption of magnesium ions in the intestines using hydrophilic polymer beads. Polymer beads containing magnesium hydroxide may be used for neutralizing the acidity of the stomach and intestines. Meanwhile, zinc ions are essential for about 200 kinds of various enzymes in vivo and necessarily required for the activity of growth hormones and the activity of blood glucose control hormones in diabetes. Therefore, the polymer beads containing zinc hydroxide or zinc carbonate can be used as sustained-release preparations where the zinc compound contained in the polymer beads is released at a required amount in a required tissue. In case of lead sulfide, there is a report that nanosized lead sulfide crystals can act as a semiconductor (T D Krauss, F W Wise, and D B Tanner, Physical Review Letters, 76: 1376-1379, 1996; J Z Zhang, 6^{th} Forsight Conference on Molecular nanotechnology, 1998). Thus, if the nanosized lead sulfide crystals in polymer beads form a cluster, the cluster can show the characteristics of a semiconductor. Moreover, since lead sulfide with the semiconductor properties can show signals by changing electronic or optical energy in suitable conditions, sulfide lead contained in polymer beads can be used for in vivo imaging and the like.

The in vivo ingestion of the water-insoluble inorganic compounds having the respective in vivo functions as described above is not easy because of their characteristics. Thus, if the water-insoluble inorganic compounds are encapsulated in a biocompatible polymer so as to form beads, the in vivo ingestion of the water-insoluble inorganic compounds will be easy depending on the biocompatibility of the polymer. Also, if the characteristics of the polymer are controlled, the water-insoluble inorganic compounds can be exposed in vivo when required. Accordingly, the inventive method can make the in vivo use of the water-insoluble inorganic compounds very easy. Also, entangled connections between the molecules (i.e., matrices), which are the characteristics of polymers, are provided to make it possible to prepare a support of a certain shape by gelation, sol-gel change or molding using material characteristics which cannot be provided with water-insoluble inorganic compounds. These effects of the present invention cannot be expected or induced by the simple mixing of the water-insoluble inorganic compound with the polymer.

In still another embodiment of the present invention, in order to examine the utility of the calcium sulfate-containing chitosan beads prepared according to the present invention, an injectable bone-filling material containing the chitosan beads was prepared and its effect was examined. As a result, it could be seen that the bone-filling material containing the calcium sulfate-containing chitosan beads of the present invention promoted the formation of new bone. And its effect was superior to a bone-filling material containing only chitosan beads or calcium sulfate powder (see FIG. 13). From these results, it could be seen that the encapsulation of calcium sulfate in chitosan beads increase in the utility of calcium sulfate which not only has limitations on in vivo migration and absorption but also is difficult to induce binding to other substances. Also, the effects of chitosan and calcium sulfate on the promotion of bone formation and bone regeneration were further increased.

Accordingly, the present invention provides a bone-filling composition containing the inventive polymer beads. The bone-filling composition may preferably contain chitosan beads having calcium sulfate or calcium phosphate tribasic encapsulated therein. The bone-filling composition according to the present invention can be prepared by mixing the inventive polymer beads with a polymer. The polymer may be a modified or natural polysaccharide, and preferably a viscous polysaccharide. The polymer which can be used in the inventive composition may be any one selected from the group consisting of carboxymethylcellulose, hyaluronic acid, chitosan, chitin, polyacrylic acid, polyvinyl esters, polystyrene, cellulose ethers, cellulose esters, starches, glucosaminoglycan, chondroitin sulfate, keratan sulfate, dermatan sulfate, heparin and heparin sulfate, but is not limited thereto. Preferably, hyaluronic acid or chitosan may be used. The chitosan may be prepared into a chitosan solution by dissolving it in any solvent selected from the group consisting of 1-2% (v/v) acetic acid, 0.5-1M DL-malic acid and 0.5-2M L-ascorbic acid. Preferably, the chitosan solution may be prepared by dissolving 1-5% (w/v) chitosan with a molecular weight of 100,000-600,000 kDa in 0.5-1M maleic acid or 0.5M ascorbic acid. Alternately, it can be prepared by dissolving 3% (w/v) chitosan with a molecular weight of 100,000 in 2% (v/v) acetic acid.

Furthermore, the bone-filling composition according to the present invention may additionally contain materials known in the art, which have functions related with tissue regeneration, bone regeneration, bone hardening and/or bone formation. For example, the materials include βig-h3, TGF-β, FGF, IGF-1, PDGF, bone morphogenic protein (BMP), polylactic acid (PLA), polyglycolic acid (PGA), and collagen (Beck et al., J. Bone Miner. Res., 6:961, 1991; Dieudonne et al., J. Cell Biochem., 76:231-243, 1999; Zegzula et al., J. Bone Join. Surg., 79:1778, 1997). In addition, the composition according to the present invention may be formulated with varieties of other pharmaceutically acceptable additives, such as excipients, disintegrants, fragrances, and lubricants. A preferred formulation is injectable.

### BRIEF DESCRIPTION OF THE DRAWINGS

FIG. 1 is a schematic flow chart showing an inventive method for preparing polymer beads having a water-insoluble inorganic compound encapsulated therein.

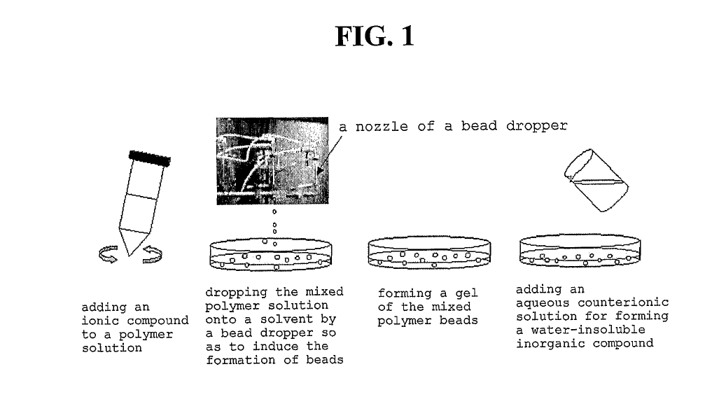

FIG. 2 shows the comparison between methods for preparing calcium sulfate-containing chitosan beads according to <Comparative Example 1> and <Example 1>.

FIG. 3 shows scanning electron microscopy (SEM) photographs of calcium sulfate-containing chitosan beads according to the present invention.

A: the appearance of a freeze-dried bead;

B: the cross-section of a freeze-dried bead;

C: the appearance of a heat-dried bead; and

D: the cross-section of a heat-dried bead.

FIG. 4 is a diagram showing the results of thermogravimetric analysis of calcium sulfate-containing chitosan beads according to the present invention.

FIG. 5 shows SEM photographs showing the results of observation of calcium sulfate crystals after thermal decomposition.

FIG. 6 shows the results of X-ray diffraction analysis for calcium sulfate crystals.

A: X-ray diffraction analysis (CaSO₄.2H₂O) of powder obtained by grinding beads; and

B: X-ray diffraction analysis (CaSO₄) for powder obtained by the thermal decomposition of beads

FIG. 7 is a diagram showing the release pattern of calcium ions.

FIG. 8 shows optical microscopy photographs and electronic microscopy photographs of polymer beads prepared using various solvents.

FIG. 9 is a diagram showing the results of comparative measurement by thermogravimetric analysis for the amount of calcium sulfate contained in polymer beads prepared using various solvents.

FIG. 10 shows optical microscopy photographs and scanning electron microscopy photographs of polymer beads having various water-insoluble inorganic compounds encapsulated therein, respectively.

FIG. 11 shows scanning electronic microscopy photographs of inorganic compound crystals obtained by the thermal decomposition of polymer beads containing various water-insoluble inorganic compounds.

FIG. 12 shows the results of X-ray diffraction analysis showing the comparison between inorganic compounds (A) obtained by the thermal decomposition of various water-insoluble inorganic compounds and a reference material (B).

FIG. 13 shows the results of analysis for the tissue of new bone formation by the use of the inventive calcium sulfate-containing chitosan beads as bone filling beads. Arrows indicate cut sites.

A: injected with physiological saline; B: injected with hyaluronic acid;

C: injected with a composition obtained by mixing chitosan beads containing no calcium sulfate with hyaluronic acid;

D: injected with a composition obtained by mixing calcium sulfate powder with hyaluronic acid; and

E: injected with a composition obtained by mixing the inventive calcium sulfate-containing chitosan beads with hyaluronic acid.

### BEST MODE FOR CARRYING OUT THE INVENTION

Hereinafter, the present invention will be described in detail by examples. It is to be understood, however, that these examples are provided for illustrative purpose only and are not construed to limit the scope of the present invention.

### EXAMPLE 1

### Preparation of Calcium Sulfate-Containing Chitosan Beads using Oil-Base Solvent

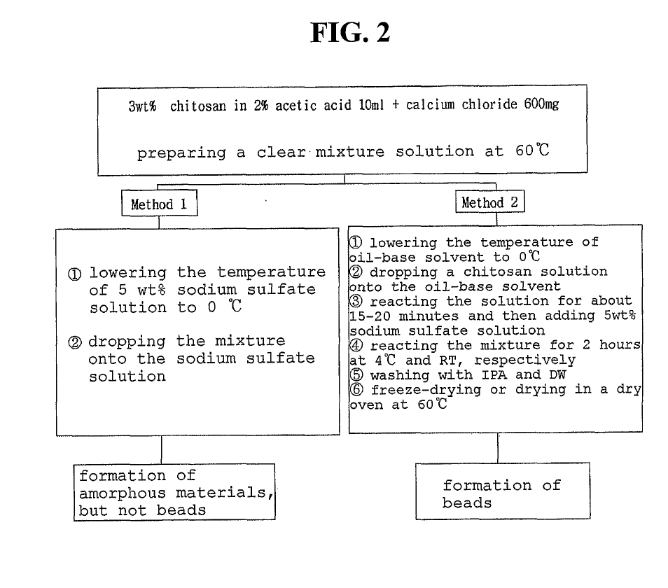

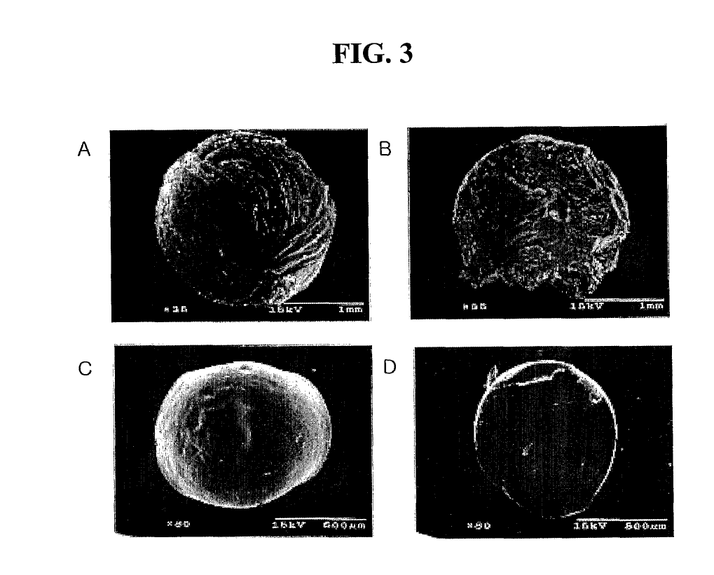

First, a chitosan solution was prepared by dissolving 3% (w/v) chitosan in 10 ml of 2% (v/v) acetic acid. 600 mg of calcium chloride (CaCl₂) was added to the prepared chitosan solution. Then, the mixture was stirred at 60° C. for 60 minutes. The chitosan solution having calcium chloride dissolved therein was dropped onto a plate containing 0° C. oil-base solvent (Acros Organics, Belgium) by means of a bead dropper (see FIG. 2). The resulting plate was left to stand in a frozen condition for 15-20 minutes so as to form beads. 5% (w/v) sodium sulfate (Na₂SO₄) solution was added to the plate. Following this, the mixture was reacted at 4° C. for 2 hours to induce the crosslinking of the bead surface while maintaining the gel state of chitosan. Next, the mixture was reacted at room temperature (RT) for 2 hours to induce the crosslinking by sodium sulfate and the formation of inorganic salt crystals in the beads. After completion of the reaction, the product washed at least five times with IPA (isopropylalcohol) until the oil-base solvent was removed. Then, it washed at least five times with distilled water. The product was either freeze-dried or heat-dried in a dry oven at 60° C. As a result, it was shown that beads were formed (see FIG. 3).

### COMPARATIVE EXAMPLE 1

### Preparation of Calcium Sulfate-Containing Chitosan Beads without Using Solvent

According to the same method as in <Example 1>, calcium chloride was added to a chitosan solution. Then, the chitosan solution having calcium chloride dissolved therein was dropped onto 5% (w/v) sodium sulfate solution at 0° C. using a bead dropper (see FIG. 2). Next, the same procedures as in <Example 1> were performed. As a result, amorphous materials, but not beads, were formed (data not shown).

From the above results, it could be found that the method of <Example 1> comprising gelling the calcium chloride-containing chitosan solution with the low-temperature oil-base solvent and then crosslinking chitosan with the sulfate ions by adding sulfate calcium thereto was more effective in producing the beads than the method of <Comparative Example 1> comprising dropping the calcium chloride-containing chitosan solution directly onto the calcium sulfate solution.

### TEST EXAMPLE 1

### Analysis of Characteristics of Calcium Sulfate-Containing Chitosan Beads

The characteristics of shape and content of the calcium sulfate-containing chitosan beads prepared in <Example 1> were analyzed in the following manner.

<1-1> Scanning Electron Microscopy of Calcium Sulfate-Containing Chitosan Beads

The calcium sulfate-containing chitosan beads were observed with a scanning electron microscope (SEM), and the results were shown in FIG. 3. As shown in FIG. 3, the beads prepared in <Example 1> had a spherical shape. This suggests that sulfate ions effectively crosslink chitosan. A freeze-dried bead was about 2.0-2.5 mm in diameter (see FIG. 3A), and had a porous structure when observed the cross-section of the bead (see FIG. 3B). On the other hand, a bead hardened by heat-drying in an oven was shrunk to 1.0-1.5 mm in diameter (see FIG. 3C), and had a high-density structure when observed its cross-section (see FIG. 3D).

<1-2> Thermogravimetric Analysis

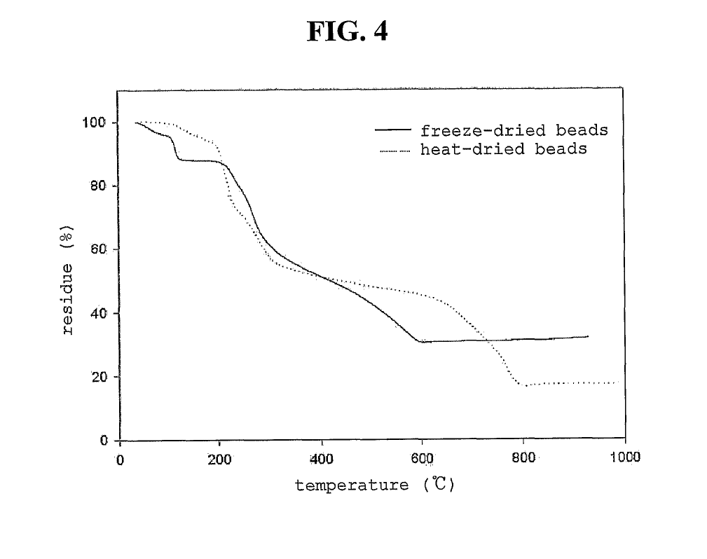

Thermogravimetric analysis (TGA) (Inorganic thermogravimetric analysis 2nd ed. Ralph E. Oesper translated Duval, Claement. cn Amsterdam, N.Y., Elsevier Pub. Co., 1963) was performed to examine whether calcium sulfate was encapsulated in the chitosan beads prepared in <Example 1> and to examine the content of calcium sulfate encapsulated therein. The analysis results were shown in FIG. 4. Changes in the weight of the beads according to temperature were examined while heating from room temperature to 1000° C. at a rate of 20° C./min under the condition of purging with inert nitrogen gas for the prevention of oxidation. As a result, at less than 100° C., hydrated water molecules were vaporized slowly, and then, a rapid change in weight was shown at around 150° C. since calcium sulfate dihydrate was changed into hemihydrate. Above 200° C., the decomposition of chitosan started and proceeded up to about 600° C. for the freeze-dried beads and up to about 800° C. for the heat-dried beads with a more compact structure. The content of the inorganic compound was maintained up to 1,000° C. The content of the inorganic material contained in the beads was calculated by comparing the weight of the inorganic material remaining after the thermal decomposition to the weight of the chitosan beads prior to the thermal decomposition. As a result, the content of calcium sulfate in the chitosan beads was about 10-30% depending on the drying processes.

<1-3> Scanning Electron Microscopy of Inorganic Material Obtained after Thermal Decomposition of Calcium Sulfate-Containing Chitosan Beads

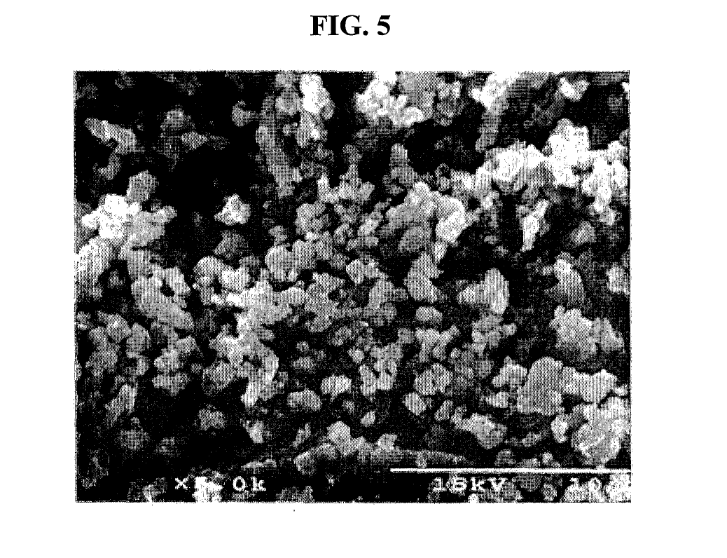

The calcium sulfate-containing beads (freeze-dried beads) obtained in <Example 1> were thermally decomposed up to 600° C. so as to obtain an inorganic compound. The obtained inorganic compound was observed with an electron microscope, and the result was shown in FIG. 5. As shown in FIG. 5, it was observed that small uniform crystal units in the submicrometer range were produced.

<1-4> X-Ray Diffraction Analysis

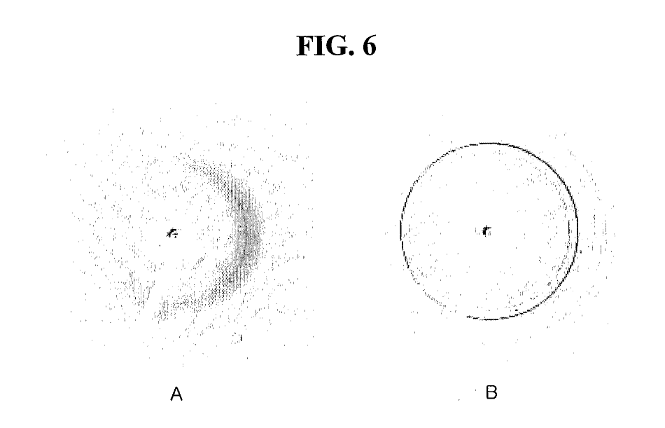

In order to examine whether an inorganic compound contained in the chitosan beads prepared in <Example 1> is calcium sulfate produced by the reaction between calcium chloride and sodium sulfate used in the preparation process and to examine the crystalline structure of the inorganic compound, X-ray diffraction analysis was performed (Elements of Modem X-ray Physics, Jens Als-Nielsen and des McMorrow, John Eiley & Sons, Ltd., 2001; B E Waren, General Publishing Company, 1969, 1990; Elements of X-ray Diffraction, 2nd Ed., B D Cullity, Addison-Wesley, 1978; and High Resolution X-ray Diffractometry and Topography, D K Bowen and B K Tanner, Taylor & Francis, Ltd., 1998). The results were shown in FIG. 6.

In the X-ray diffraction analysis of powder obtained by finely grinding the chitosan beads prepared in <Example 1>, it could be clearly observed the crystalline structure of calcium sulfate dihydrate (see FIG. 6A). Also, the X-ray diffraction pattern of powder obtained by the thermal decomposition of the chitosan beads was shown in FIG. 6B and coincident with the crystalline pattern of calcium sulfate anhydride (data not shown).

<1-5> Measurement of Release Concentration of Free Calcium Sulfate Ions

The chitosan beads prepared in <Example 1> were placed in an e-tube, and free calcium ions were quantitatively measured using 0.9% saline as release media.

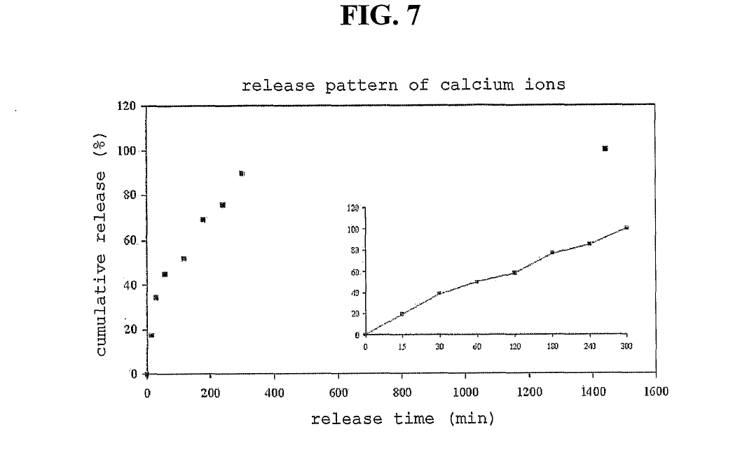

The quantified amount of calcium ions was considered to be released from the chitosan beads according to the present invention. The results were shown in FIG. 7. Most of calcium sulfate encapsulated in the inventive chitosan beads was released within about 6-8 hours.

### EXAMPLE 2

### Preparation of Calcium Sulfate-Containing Chitosan Beads using Various Solvents

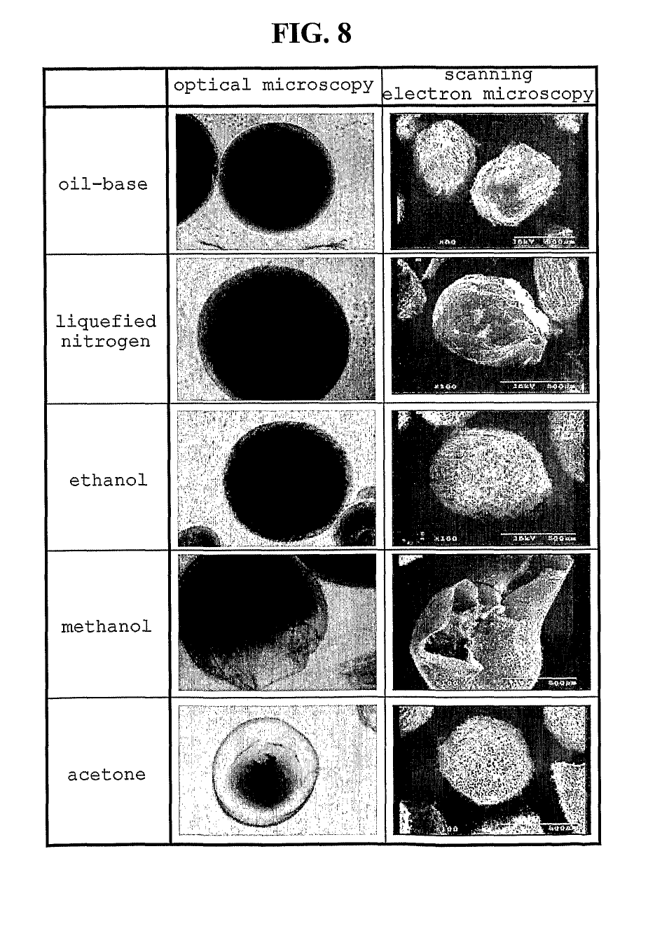

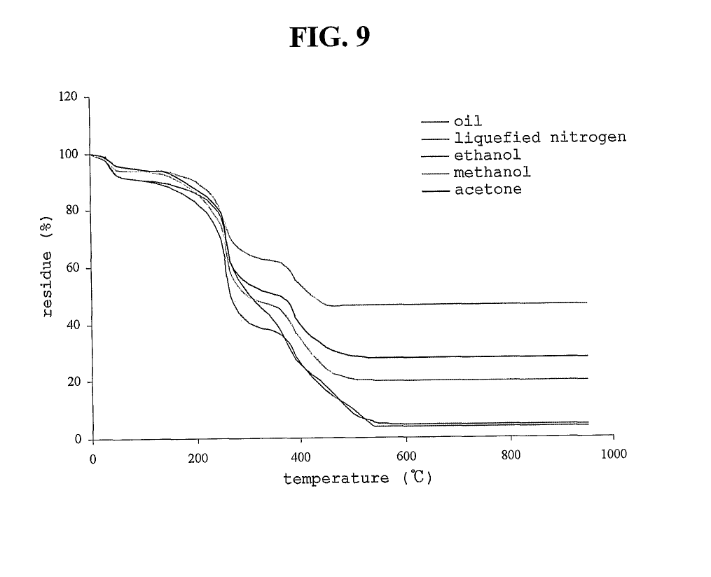

The present inventors attempted to form beads using other solvents than the oil-base solvent. The beads were prepared in the same manner as in <Example 1> except that ethanol, acetone, liquefied nitrogen and methanol were used as solvents. As a result, it was found that the beads were formed in all the solvents (see FIG. 8). In the case of ethanol, the beads were well formed, particularly when the use temperature of ethanol was lowered to about −30° C. with dry ice. In case of other solvents than ethanol, although the calcium sulfate content in each bead was different (data not shown), the beads were all well formed regardless of the reaction temperature in adding sodium sulfate. Thernogravimetric analysis was performed in the same manner as in <Test Example 1-2> and as a result, the chitosan beads prepared using ethanol showed the highest calcium sulfate content (see FIG. 9).

### EXAMPLE 3

### Preparation of Chitosan Beads Containing Various Water-Insoluble Inorganic Compounds, Respectively

Chitosan beads containing various water-insoluble inorganic compounds, respectively, were prepared using compounds shown in Table 1 below, according to the same method as in <Example 1>. As a solvent, ethanol was used.

TABLE 1
Various water-insoluble inorganic compounds

| Final metal salts | | |
|---|---|---|
| (water-insoluble | Mixing compartments | |
| inorganic compounds) | Cationic compounds | Anionic compounds |
| Lead sulfide (PbS) | Lead nitrate | Sodium sulfide |
| | (Pb(NO₃)₂) | (Na₂S) |
| Magnesium hydroxide | Magnesium chloride | Sodium hydroxide |
| (Mg(OH)₂) | (MgCl₂) | (NaOH) |
| Calcium phosphate tribasic | Calcium chloride | Sodium phosphate |
| (Ca₃(PO₄)₂) | (CaCl₂) | dibasic (Na₂HPO₄) |
| Zinc hydroxide (Zn(OH)₂) | Zinc chloride | Sodium hydroxide |
| | (ZnCl₂) | (NaOH) |
| Zinc carbonate (ZnCO₃) | Zinc chloride | Sodium carbonate |
| | (ZnCl₂) | (Na₂CO₃) |

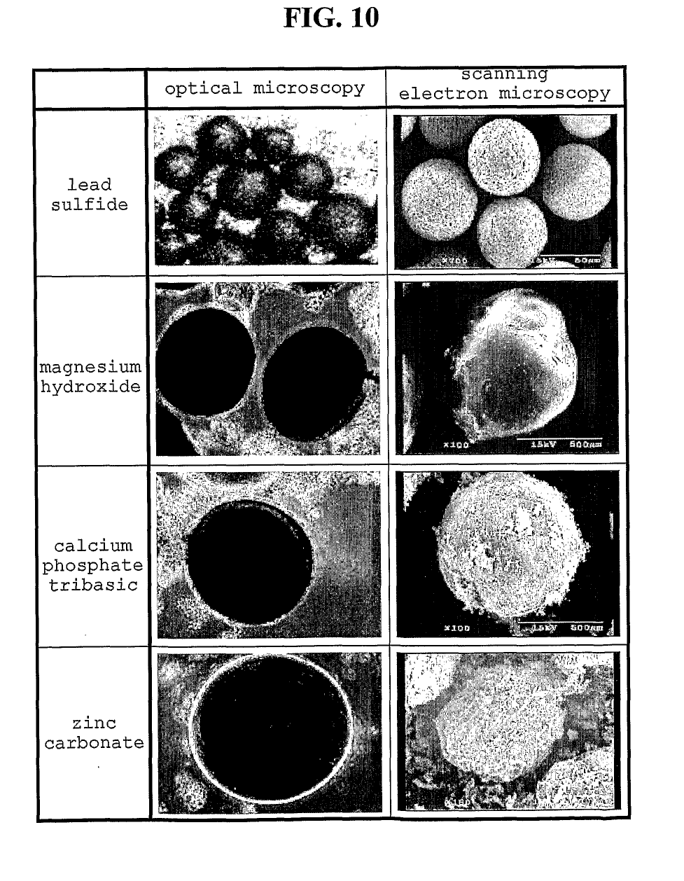

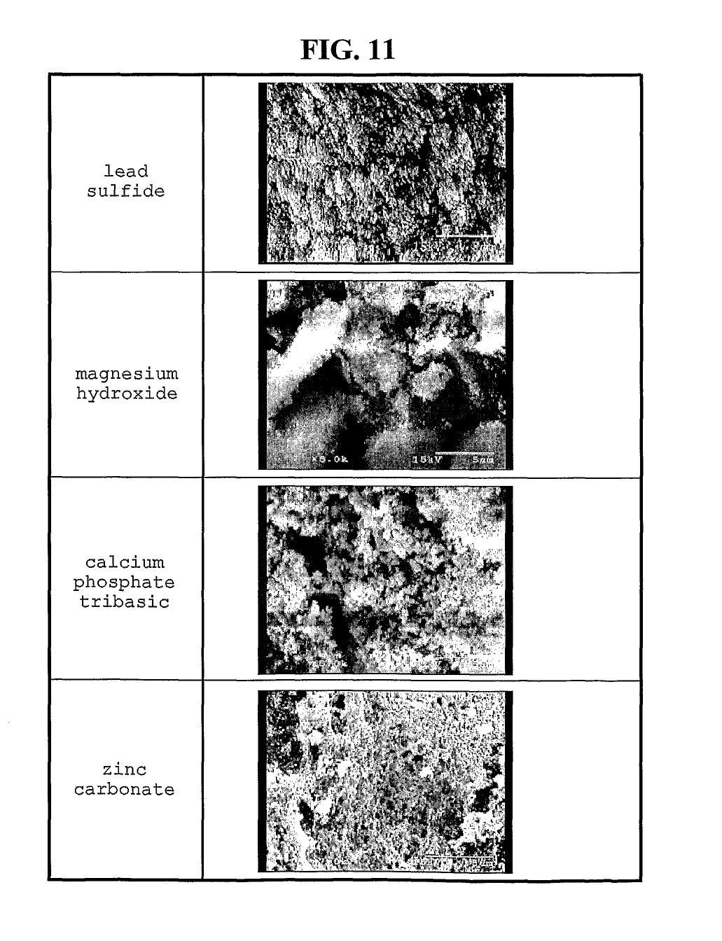

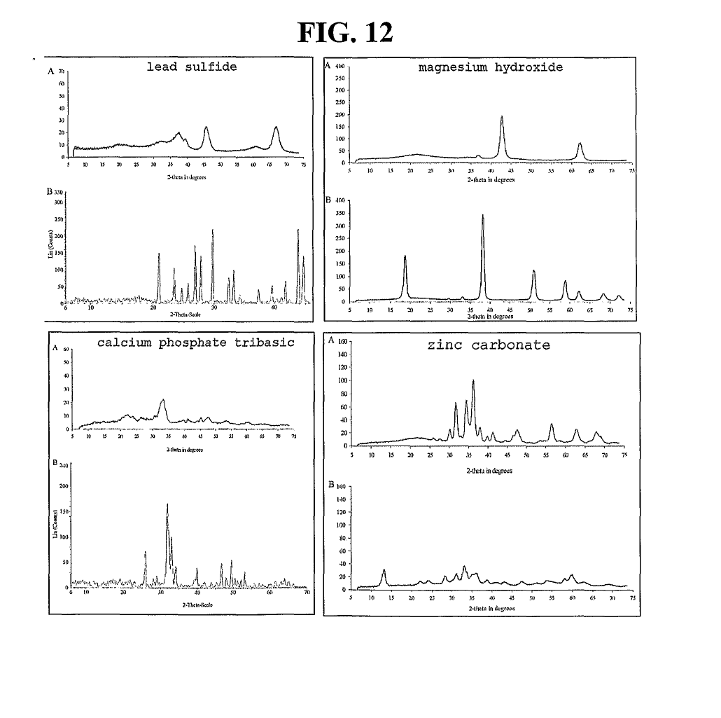

First, each of the cationic compounds was mixed with chitosan so as to prepare a mixed solution. The mixed solution was dropped onto a plate containing −30° C. ethanol using a bead dropper. The solution was reacted for 15-20 minutes so as to form beads. Then, each of the anionic compounds solution was added to the formed beads so as to prepare chitosan beads containing each of various water-insoluble inorganic compound crystals. An optical microscopy photographs and scanning electron microscopy photographs of each of the prepared chitosan beads were shown in FIG. 10. Also, the characteristics of the prepared beads were analyzed in the same manner as in <Test Example 1> by thermogravimetric analysis and by the photographic observation and X-ray diffraction analysis of precipitated crystals remaining after the thermogravimetric analysis. As a result, as shown in FIG. 11 which is a scanning electron microscopy photograph of the precipitated crystal remaining after the thermogravimetric analysis of each of the water-insoluble inorganic compounds, it was observed that all the water-insoluble inorganic compounds had a crystalline structure. Also, the obtained inorganic compounds were subjected to X-ray diffraction analysis and compared to each of commercially available reference materials (PbS, Mg(OH)₂, Ca₃(PO₄)₂ and ZnCO₃), respectively. As shown in FIG. 12, the obtained inorganic compounds were the same as the reference materials.

From the above results, it could be seen that the present invention could prepare the polymer beads having other water-insoluble inorganic compounds than calcium sulfate encapsulated therein, respectively.

### EXAMPLE 4

### Preparation of Bone-Filling Materials Containing Polymer Beads According to the Present Invention

<4-1> Preparation of Injectable Bone-Filling Composition with Hyaluronic Acid

50 mg of the calcium sulfate-containing chitosan beads prepared in 20<Example 1> were mixed with 1 ml of 1% (w/v) hyaluronic acid and left to stand at room temperature to prepare an injectable bone-filling composition. As the calcium sulfate-containing chitosan beads were mixed with hyaluronic acid, the chitosan beads then absorbed hyaluronic acid, and after 30 minutes, the binding between the two materials occurred to obtain a gel-like material.

<4-2> Preparation of Injectable Bone-Filling Composition with Chitosan

The present inventors prepared an injectable bone-filling composition by mixing the calcium sulfate-containing chitosan beads prepared in <Example 1> with chitosan in place of hyaluronic acid. In this case, in order to prepare a gel-like chitosan solution having viscosity suitable for the injectable bone-filling, composition, each of chitosans with varying solubilities (water solubility and water insolubility), molecular weights (100,000, 270,000, 300,000 and 400,000-600,000) and concentrations (3%, 5% and 7%) was dissolved in each of 0.5M or 1M maleic acid and 0.5M ascorbic acid. With each of the solutions, an injectable bone-filling composition was prepared in the same manner as in <Example 4-1>.

As a result, the water-soluble chitosan was too low in viscosity to use it as a matrix of bone-filling compositions, and the high-molecular weight chitosan solution was higher in viscosity than the low-molecular weight chitosan solution. The chitosan with a molecular weight of more than 600,000 had a problem in that it is not well dissolved in low-concentration acid solutions. Particularly, it was shown that the gel-like chitosan solution prepared by dissolving 3% (w/v) chitosan with a molecular weight of 400,000-600,000 in 0.5M maleic acid had the most suitable viscosity and solubility for bone filling compositions (data not shown). When the calcium sulfate-containing chitosan beads prepared in the present invention were mixed with the gel-like chitosan solution, the immobilized shape just started to appear, unlike the case of mixing with hyaluronic acid.

### TEST EXAMPLE 2

### Test of Effect of Inventive Bone-Filling Material

The bone-filling composition prepared in <Example 4-1> was tested for a bone regeneration effect on bone filling in an animal model by the use of an 18-gauge injection needle. For test animals, dogs were used. A bone distraction device was placed in the lower jawbone of the dogs, and the middle thereof was cut. The bone distraction device was so controlled that the interval between the bones widened 1 mm per day. After 10 days, the distraction length of the bones reached about 10 mm and the bone-filling composition (the composition obtained by mixing the calcium sulfate-containing chitosan beads with hyaluronic acid) prepared in <Example 4-1> was injected into the produced bone cavity. As a control, each of physiological saline, hyaluronic acid, a composition obtained by mixing chitosan beads containing no calcium sulfate with hyaluronic acid, and a composition obtained by mixing calcium sulfate powder (Osteoset®, WrightMedical Technology, Inc.) with hyaluronic acid was injected. Then, the formation of bone was observed with the passage of time.

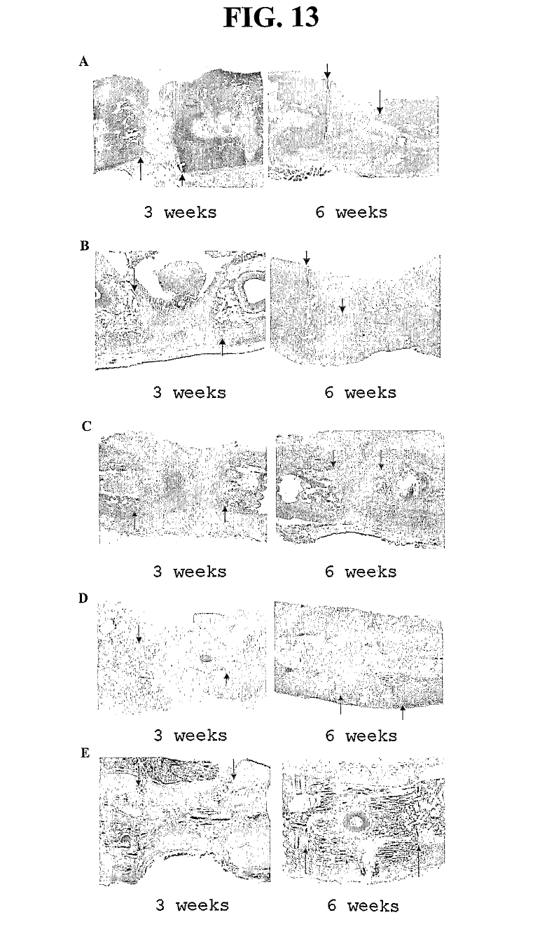

As shown in FIG. 13, the newly formed bone tissues (indicated by arrows) in the middle of the bone cutout sites were stained and the results showed that injection with the inventive calcium sulfate-containing chitosan beads induced the smallest fibrosis tissue and also the most abundant bone formation. Specifically, injection with physiological saline induced the general fibrosis in the bone cutout at 6 weeks after the injection (see FIG. 13A), and injection with only hyaluronic acid or the composition obtained by mixing the chitosan beads containing no calcium sulfate with hyaluronic acid, induced the fibrosis in most of the bone cutout at 6 weeks after the injection although bone was formed in some parts of bone cutout (see FIGS. 13B and C). Injection with the composition obtained by mixing calcium sulfate powder with hyaluronic acid induced new bone only at the edge at 3 weeks after the injection and the frail bone formation at 6 weeks (see FIG. 13D). On the other hand, injection with the composition obtained by mixing the inventive calcium sulfate-containing chitosan beads with hyaluronic acid induced new bone even at 3 weeks and the well-made bone formation at 6 weeks (see FIG. 13E).

From the above results, it could be found that the encapsulation of calcium sulfate in chitosan beads according to the present invention allowed an increase in the utility of calcium sulfate which not only has limitations on in vivo use because of the characteristic of precipitates in an aqueous solution but also is difficult to induce binding to other substances. Also, the encapsulation allowed the induction of the synergistic effect of chitosan and calcium sulfate on the promotion of bone formation and bone regeneration. Furthermore, the bone-filling material according to the present invention showed no inflammatory reaction, indicating a safe material (data not shown).

### INDUSTRIAL APPLICABILITY

As described above, in the present invention, the water-insoluble inorganic compound which has limitations on its use because of the characteristic of precipitates in an aqueous solution is encapsulated in the polymer beads. This encapsulation provides an increase in the utility of the water-insoluble inorganic compound and at the same time, imparts the activity of the water-insoluble inorganic compound to the polymer, thus increasing the function of the polymer. Accordingly, the polymer beads having the water-insoluble inorganic compound encapsulated therein, which are prepared by the inventive method, can be advantageously used in various fields, including medical and electronic industries.

1. Polymer beads having a water-insoluble inorganic compound encapsulated therein.

2. The polymer beads of claim 1, wherein the water-insoluble inorganic compound is any one selected from the group consisting of calcium sulfate (CaSO₄), lead sulfide (PbS), magnesium hydroxide (Mg(OH)₂), zinc hydroxide (Zn(OH)₂), zinc carbonate (ZnCO₃) and calcium phosphate tribasic(Ca₃(PO₄)₂).

3. The polymer beads of claim 1, wherein the polymer is any one selected from the group consisting of chitosan, alginic acid and hyaluronic acid.

4. A method for preparing polymer beads having a water-insoluble inorganic compound encapsulated therein, the method comprising the steps of:
(a) mixing a polymer solution with a compound having a ionic group of a water-insoluble inorganic compound;
(b) inducing dropping onto a solvent the mixed solution prepared in the step (a) so as to induce the formation of beads;
(c) reacting the beads formed in the step (b) with an aqueous solution of a compound having a counter-ionic group to the ionic group in the step (a); and
(d) washing and drying the beads resulting from the step (c).

5. The method of claim 4, wherein the polymer in the step (a) is any one selected from the group consisting of chitosan, alginic acid and hyaluronic acid.

6. The method of claim 4, wherein the ionic group in the step (a) is the same ionic group as a reactive group of the polymer.

7. The method of claim 6, wherein the compound is any one selected from the group consisting of calcium chloride (CaCl₂), lead nitrate (Pb(NO₃)₂), magnesium chloride (MgCl₂), zinc chloride (ZnCl₂), sodium sulfate (Na₂SO₄), sodium sulfide (Na₂S), sodium hydroxide (NaOH), sodium phosphate dibasic (Na₂HPO₄) and sodium carbonate (Na₂CO₃).

8. The method of claim 4, wherein the mixing in the step (a) is conducted at a temperature of 18-60° C.

9. The method of claim 4, wherein the solvent in the step (b) is any one selected from the group consisting of oil-base solvent, ethanol, acetone, liquefied nitrogen, and methanol.

10. The method of claim 4, wherein the temperature of the solvent in the step (b) is in a range of −270° C. to 10° C.

11. The method of claim 4, wherein the compound having the counterionic group in the step (c) is any one selected from the group consisting of calcium chloride (CaCl₂), lead nitrate (Pb(NO₃)₂), magnesium chloride (MgCl₂), zinc chloride (ZnCl₂), sodium sulfate (Na₂SO₄), sodium sulfide (Na₂S), sodium hydroxide (NaOH), sodium phosphate dibasic (Na₂HPO₄) and sodium carbonate (Na₂CO₃).

12. The method of claim 4, wherein the water-insoluble inorganic compound is any one selected from the group consisting of calcium sulfate (CaSO₄), lead sulfide (PbS), magnesium hydroxide (Mg(OH)₂), zinc hydroxide (Zn(OH)₂), zinc carbonate (ZnCO₃) and calcium phosphate tribasic(Ca₃(PO₄)₂).

13. A bone-filling composition comprising the polymer beads of claim 1, the polymer beads having water-insoluble inorganic compounds encapsulated therein.

14. The composition of claim 13, wherein the polymer beads are chitosan beads having calcium sulfate or calcium phosphate tribasic encapsulated therein.

15. The composition of claim 13, wherein the composition further comprises a polymer.

16. The composition of claim 15, wherein the polymer is any one selected from the group consisting of chitosan, carboxymethylcellulose, hyaluronic acid, chitin, polyacrylic acid, polyvinyl esters, polystyrens, cellulose ethers, cellulose esters, starches, glucosaminoglycan, chondroitin sulfate, keratan sulfate, dermatan sulfate, heparin and heparin sulfate.

17. The composition of claim 16, wherein the chitosan is used as a chitosan solution prepared by dissolving the chitosan in any solvent selected from the group consisting of 1-2% (v/v) acetic acid, 0.5-1M DL-malic acid and 0.5-2M L-ascorbic acid.
